(19) United States
(12) Patent Application Publication
(10) Pub. No.: US 2007/0185640 A1
(43) Pub. Date: Aug. 9, 2007

(54) Adaptive control of a cam phase adjustment mechanism

(76) Inventors: Jeffrey M. Pfeiffer, Walled Lake, MI (US); Amanpal S. Grewal, Novi, MI (US); Daniel Lee McKay, Brighton, MI (US)

Correspondence Address: JIMMY L. FUNKE;DELPHI TECHNOLOGIES, INC., P. O. Box 5052, Legal Staff - Mail Code: 480-410-202, Troy, MI, 48007-5052, US

(21) Appl. No.: 10/668,384

(22) Filed: Sep. 23, 2003

(51) Int. Cl. G06G 7/70

(52) U.S. Cl. 701/101

(57) ABSTRACT

A closed-loop control for a cam phase adjustment mechanism includes gain terms that are adaptively adjusted to optimize the rate of response of the control to changes in the desired cam phase. The rate of response of the cam phase adjustment mechanism is sampled under specified operating conditions or during certain repeated engine events that involve a change in the desired cam phase, and the deviation of the measured rate of response from the nominal rate of response is determined and used to adjust the closed-loop control gains for restoring the nominal response.

### TECHNICAL FIELD

The present invention is directed to a control for a cam phase adjustment mechanism of an internal combustion engine, and more particularly to a method of adaptively adjusting the control so as to optimize its rate of response to changes in the desired cam phase.

### BACKGROUND OF THE INVENTION

Mechanisms for adjusting the phase of a camshaft (intake and/or exhaust) relative to the crankshaft for purposes of reducing exhaust gas emissions and improving engine performance are well known in the art of internal combustion engine controls. The adjustment mechanism typically includes a hydraulic actuator supplied by an engine-driven oil pump, and the actuator is electrically activated by a closed-loop controller based on cam phase error. Since the overall system is highly nonlinear, the control system designer will typically want to schedule the closed-loop control gains based on a number of measured hydraulic properties such as cam torque and oil temperature, pressure, aeration, leakage and viscosity, and so on. However, it is impractical to measure or accurately estimate more than a small fraction of these parameters, particularly in a high volume production system for a motor vehicle, and it is difficult to maintain nominal control system performance under non-nominal operating conditions. Accordingly, what is needed is an improved control in which the closed-loop control gains are adaptively adjusted to maintain near-nominal control system performance under diverse operating conditions.

### SUMMARY OF THE INVENTION

The present invention is directed to an improved closed-loop control for a cam phase adjustment mechanism, wherein the control gains are adaptively adjusted so as to optimize the rate of response of the control to changes in the desired cam phase. According to the invention, the rate of response of the cam phase adjustment mechanism is sampled under specified operating conditions or during certain repeated engine events that involve a significant change in the desired cam phase, and the deviation of the measured rate of response from the nominal rate of response is determined and used to adjust the closed-loop control gains for restoring the nominal response. Preferably, the nominal response is calculated based on both fixed and learned response schedules so that the nominal response can be optimized for a particular vehicle.

### BRIEF DESCRIPTION OF THE DRAWINGS

FIG. 1 is a diagram of a motor vehicle power plant, including an internal combustion engine equipped with a cam phase adjustment mechanism and a microprocessor-based engine control module for activating the cam phase adjustment mechanism.

FIG. 2, Graphs A-B, respectively depict the response of the cam phase adjustment mechanism of FIG. 1 to first and second requested changes in cam phase position.

FIG. 3 is a block diagram of a control carried out by the engine control module of FIG. 1 according to this invention.

FIG. 4 is a flow diagram detailing the functionality of a block shown in FIG. 3 pertaining to testing of the cam phase response.

FIG. 5 is a flow diagram detailing the functionality of a block shown in FIG. 3 pertaining to adaptive logic for adjusting closed-loop control gains.

### DESCRIPTION OF THE PREFERRED EMBODIMENT

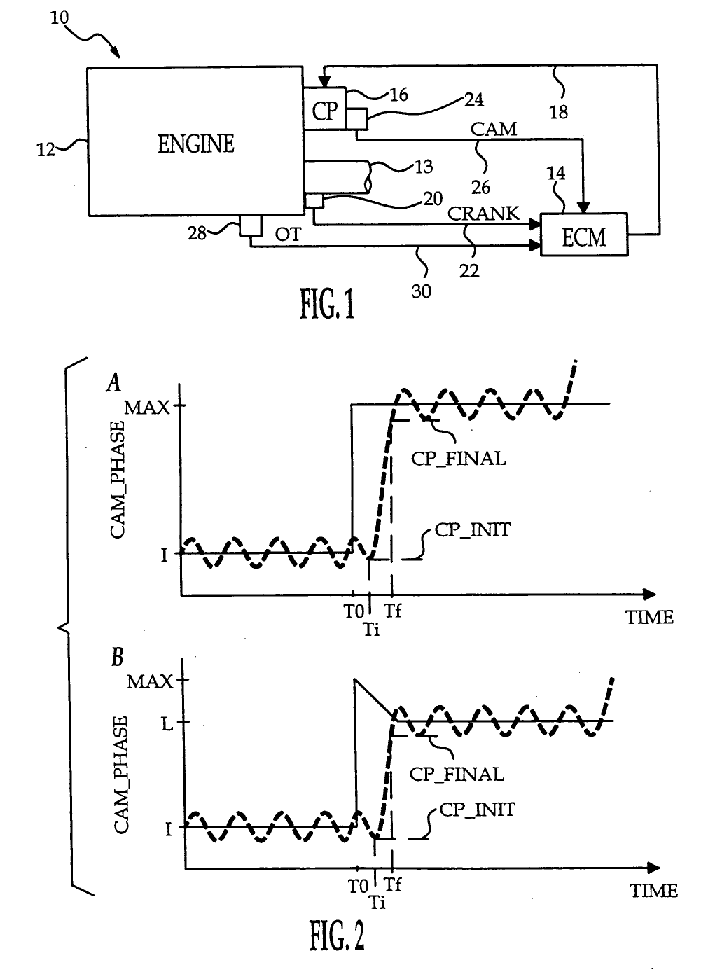

Referring to FIG. 1, the reference numeral 10 generally depicts a motor vehicle powertrain including an internal combustion engine 12 having an output shaft 13 and a microprocessor-based engine control module (ECM) 14. The engine 12 is equipped with a cam phase adjustment mechanism (CP) 16 that controls the phase relationship between the engine camshaft(s) and crankshaft in response to a control signal produced by ECM 14 on line 18. A crankshaft position sensor 20 is responsive to the passage of teeth formed on a flywheel attached to output shaft 13, and produces a CRANK signal on line 22. Similarly, a camshaft position sensor 24 is responsive to the passage of teeth formed on a wheel attached to the camshaft, and produces a CAM signal on line 26. Finally, an oil temperature sensor 28 responsive to the temperature of oil supplied to the cam phase adjustment mechanism 16 produces an oil temperature signal (OT) on line 30.

The ECM 14 carries out a number of control routines for operating engine 12, most of which are conventional in nature and therefore not addressed herein. In relation to the present invention, for example, ECM 14 includes a conventional control routine for determining the desired and actual cam phases, and a proportional-integral-differential (PID) closed-loop control for adjusting the control signal on line 22 to bring the actual cam phase into correspondence with the desired cam phase. The present invention is directed to a routine carried out by ECM 14 for monitoring the rate of response of the cam phase control and adaptively adjusting the PID control gains in response to significant deviation of the measured rate of response from the nominal rate of response for the purpose of maintaining or restoring the nominal response.

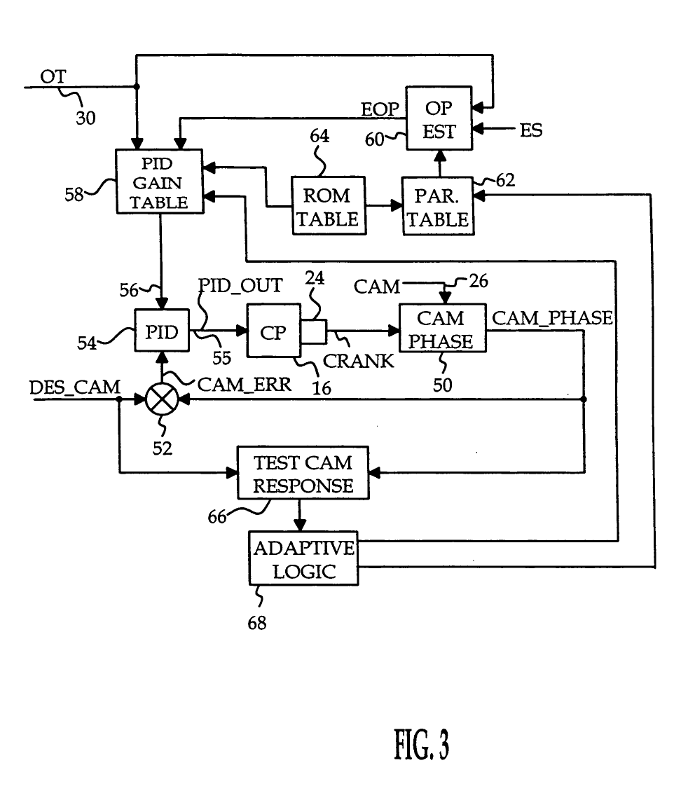

Graphs A and B of FIG. 2 respectively depict the response of the control system of FIG. 1 to two different changes in the requested cam phase. In each case, the solid trace depicts the requested cam phase, and the broken trace depicts the actual cam phase. In the example of Graph A, the requested cam phase changes from an initial value I to a maximum value MAX at time t0, and is maintained at MAX for a prolonged interval; in the example of Graph B, the requested cam phase changes from initial value I to maximum value MAX at time t0, and then ramps down to a lower value L over the time interval t0-t1. The depicted changes in requested cam phase are just two examples of what might occur during engine operation, although the requested cam phase depicted in Graph A is also exemplary of what happens in certain repeated engine events such as during deceleration fuel cut off (DFCO), or during a periodic cleaning routine for the adjustment mechanism 16. In any event, one aspect of this invention lies in properly discerning the system response rate to various changes in desired cam phase.

The system response rate can be simply defined as the change in cam phase per unit time in response to a change in the desired cam phase, and can be calculated as the actual change in cam phase divided by the time required to achieve the requested change. Referring to Graphs A and B, the required time can be defined as the interval Tf-Ti, where Ti is the time at or after time T0 when the cam phase begins to change in the desired direction, and Tf is the time when the difference or error between the actual and desired cam phase falls to within a predefined dead-band. Similarly, the change in cam phase can be determined by recording initial and final cam phase values (CP_INIT, CP_FINAL) corresponding to the cam phase at times Ti and Tf, respectively. The requested step change is defined as the change in desired cam phase at time T0, or MAX-I. If the recorded change in cam phase (i.e, CP_FINAL-CP_INIT) is substantially equal to the requested change, the response is calculated based on the determined changes in time and cam phase; otherwise, the recorded data is disregarded. Thus, the data recorded for the example of Graph A will be retained, while the data recorded for the example of Graph B will be rejected because the recorded change in cam phase is significantly less than the requested change.

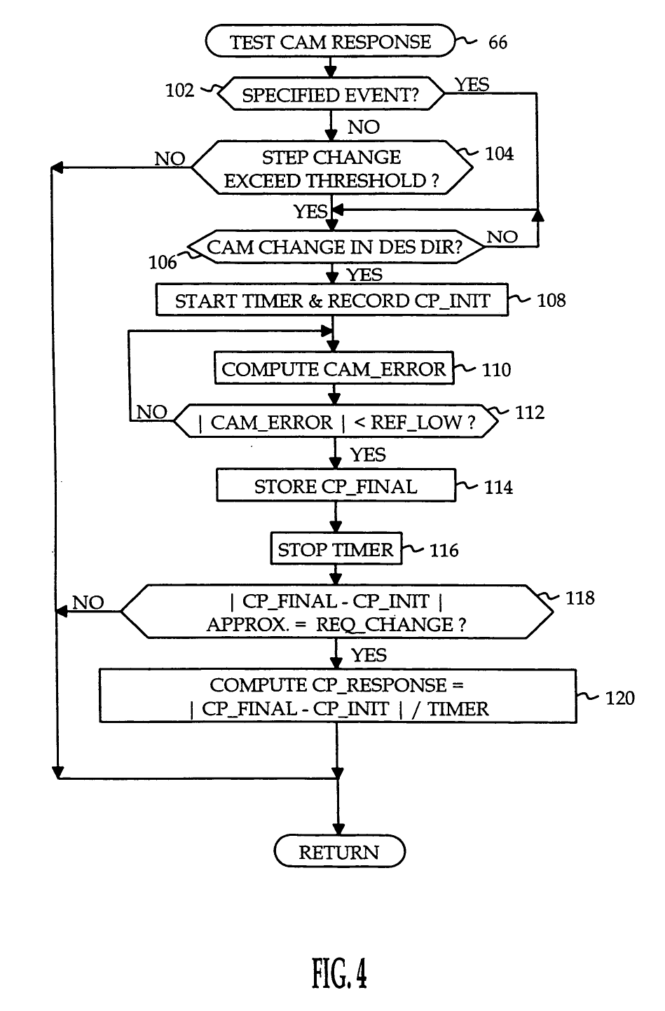

The control of cam phase adjustment mechanism 16 by ECM 14 according to this invention is depicted by the block diagram of FIG. 3, where engine oil temperature OT, engine speed ES, the cam and crank position signals CAM and CRANK, and the desired cam phase DES_CAM are shown as inputs. The engine speed input ES may be derived from the CRANK input on line 22. The block 50 computes the actual cam phase CAM_PHASE. In conventional practice, CAM_PHASE is determined by computing a displacement between the camshaft and crankshaft according to the product of engine speed ES and the time between crankshaft and camshaft position pulses, and then converting the computed displacement to a corresponding phase angle. Preferably, however, CAM_PHASE is computed according to a ratio of time intervals based on the CAM and CRANK signals, as disclosed in the U.S. patent application Attorney Docket No. DP-302615, Ser. No. 09/725,443, filed on Nov. 29, 2000. The actual and desired cam phase values are differenced at summing junction 52 to form the cam phase error signal CAM_ERR, and the PID block 54 forms the control signal PID_OUT for cam phase adjustment mechanism 16 on line 55. The output PID_OUT can be mathematically expressed as:

$$PID\_OUT = ( Kp * CAM\_ERR ) + [ Ki * INT ( CAM\_ERR ) ] + [ Kd * DIFF ( CAM\_ERR ) ]$$

where INT represents an integral function, DIFF represents a differential function, and Kp, Ki and Kd are proportional, integral and differential control gain terms supplied to block 54 on line 56. The gain terms Kp, Ki and Kd are specified by the block 58, which represents a non-volatile random access memory (NVRAM) that stores gain term values for various operating conditions defined by measured or estimated operating parameters of interest. In the illustrated embodiment, the gain terms are specified as a function of oil temperature OT and estimated oil pressure EOP, with EOP being modeled by block 60 as a function of engine speed ES and oil temperature OT. The EOP model utilizes a number of parameters that are stored in the block 62, which may be another NVRAM. Calibrated or nominal table values for the blocks 58 and 62 are permanently stored in the block 64, which represents a read-only memory (ROM) that is programmed during the manufacture of ECM 14. Initially (and thereafter in the event of an electrical power loss), the respective table values stored in block 64 are transferred to the blocks 58 and 62, and the values stored in blocks 58 and/or 62 are subject to adaptive adjustment during subsequent vehicle operation by the adaptive logic block 68 as explained below.

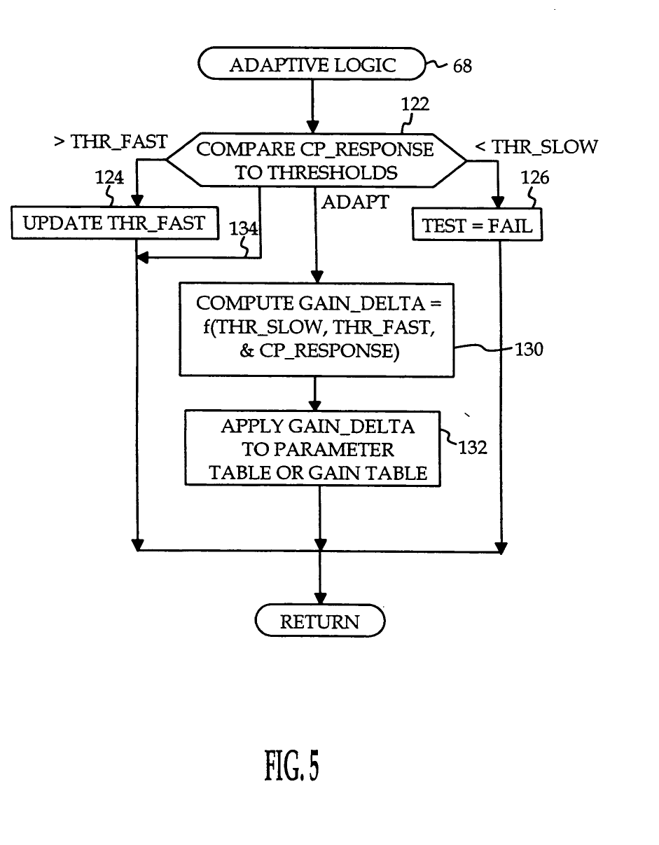

The block 66 is responsive to the DES_CAM and CAM_PHASE signals, and monitors the cam phase rate of response as described above in respect to FIG. 2. Additionally, FIG. 4 depicts a flow diagram representative of a software routine executed by the ECM 14 in response to a detected change in the desired cam phase DES_CAM. The block 102 determines if the requested change is due to a specified event such as a deceleration fuel cut off (DFCO) event, or a periodic cleaning event for the adjustment mechanism 16, while the block 104 determines if the requested change exceeds a predefined threshold. If either block is answered in the affirmative, the remaining blocks are executed to record time and cam phase parameters associated with the requested change. When CAM_PHASE begins to change in the desired direction, block 106 is answered in the affirmative, and the block 108 starts a TIMER and stores the current value of CAM_PHASE as the initial cam phase value CP_INIT. The block 110 computes the cam phase error CAM_ERR, and the block 112 detects when CAM_ERR reaches a low error threshold REF_LOW. When block 112 is answered in the affirmative, the blocks 114 and 116 store the current value of CAM_PHASE as the final cam phase value CP_FINAL and stop the TIMER. The block 118 determines if the difference (CAM_FINAL-CAM_INIT) is of comparable magnitude to the requested change. If so, the block 120 is executed to calculate the rate of response CP_RESPONSE based on CP_FINAL, CP_INIT and TIMER as described above in reference to FIG. 2; otherwise, the block 120 is skipped.

Referring again to the block diagram of FIG. 3, the Adaptive Logic block 68 is responsive to the cam phase rate data recorded by block 66, and determines if the nominal closed-loop PID gain terms Kp, Ki and Kd should be adjusted to restore the rate of response of the cam phase adjustment mechanism 16 to the nominal rate of response. Although the block diagram of FIG. 3 indicates that block 68 applies adaptive corrections to both blocks 58 and 62, the preferred and normal approach is to apply adaptive corrections only to one of the blocks 58 and 62. Adaptively adjusting the model parameters stored in block 62 increases the estimated oil pressure EOP to increase the PID gain terms produced on line 56 by gain table 58, whereas adaptively adjusting the data stored in table 58 directly increases the PID gain terms produced on line 56. Adaptive adjustment of the table 58 is utilized in applications where the oil pressure is measured instead of modeled, and in cases where the desired adaptive adjustment authority cannot be achieved by adjustment of the parameter table 62.

FIG. 5 depicts a flow diagram representative of a software routine periodically executed by ECM 14 to carry out the above-described functionality of the Adaptive Logic block 68. The block 122 compares the computed CP_RESPONSE to a set of response rate thresholds THR_FAST and THR_SLOW that respectively define faster and slower than nominal response rates. Accordingly, the nominal response rate may be defined as a specified percentage of the difference between THR_SLOW and THR_FAST. Preferably, THR_SLOW and THR_FAST are not fixed thresholds, but rather variable thresholds that reflect variations in the estimated oil pressure EOP. If CP_RESPONSE is less than THR_SLOW, the cam response has been seriously degraded, and the block 126 is executed to set a TEST flag to FAIL. Per usual diagnostic practice, setting the TEST flag to FAIL serves to increment a failure counter, and a diagnostic code is generated or displayed to the driver when the failure counter exceeds a given threshold. If CP_RESPONSE is above THR_SLOW but below the nominal response rate, the blocks 130 and 132 are executed to compute an adaptive gain adjustment (GAIN_DELTA) based on the deviation of CP_RESPONSE from the nominal response rate, and to apply the adjustment to the parameter table 62 or the PID gain table 58 as explained above in respect to FIG. 3. If CP_RESPONSE is above the nominal response rate but lower than THR_FAST, no action is taken, as indicated by the flow line 134. Finally, if CP_RESPONSE is above THR_FAST, the block 124 is executed to adaptively increase THR_FAST based on a percentage of the amount by which CP_RESPONSE exceeds THR_FAST; this effectively increases the nominal response rate, since it is defined as a specified percentage of the difference between THR_SLOW and THR_FAST.

In summary, the present invention provides a cost effective method of restoring the nominal rate of response of a cam phase adjustment mechanism by adaptively updating the closed-loop gain terms based on an observed deviation of the actual rate of response from the nominal rate of response. While described in reference to the illustrated embodiment, it is expected that various modifications in addition to those mentioned above will occur to those skilled in the art. For example, the oil pressure may be measured rather than estimated, if desired. Further, the response rate CP_RESPONSE and the response thresholds THR_SLOW and THR_FAST can be defined simply in terms of time by scheduling THR_SLOW and THR_FAST based on the requested change in cam phase and the estimated oil pressure EOP. Various mechanizations of the cam phase mechanism 16 are also possible. Accordingly, it will be understood that control methods incorporating these and other modifications may fall within the scope of this invention, which is defined by the appended claims.

1. A control method for an electrically activated mechanism that adjusts cam phase in an internal combustion engine, comprising the steps of:
measuring said cam phase and forming a closed-loop control signal for activating said mechanism based on a deviation of the measured cam phase from a requested cam phase, and one or more closed-loop gain terms;
determining a rate of response of cam phase adjustment in response to a requested change in cam phase;
comparing said determined rate of response to one or more rate thresholds defining a nominal rate of response; and
adaptively adjusting said closed-loop gain terms in a direction to increase a response rate of said mechanism if the determined rate of response is below said nominal rate of response.

2. The control method of claim 1, including the steps of:
determining an estimate of an operating parameter of said mechanism based in part on a set of stored parameter values;
calibrating closed-loop gain terms as a function of said operating parameter, and retrieving calibrated closed-loop gain terms from a memory device based on said estimate; and
adaptively adjusting said stored parameter values in a direction to increase the retrieved closed-loop gain terms if the determined rate of response is below said nominal rate of response.

3. The control method of claim 2, where said operating parameter is an oil pressure supplied to said mechanism.

4. The control method of claim 2, wherein said stored parameter values are adjusted by an amount based on a deviation of the determined rate of response from said nominal rate of response.

5. The control method of claim 1, including the steps of:
storing calibrated values of said closed-loop gain terms based on operating parameters of said engine and said mechanism; and
adaptively adjusting the stored calibrated values in a direction to increase a response rate of said mechanism if the determined rate of response is below said nominal rate of response.

6. The control method of claim 1, including the step of:
determining said rate of response of cam phase adjustment based on a time interval that starts when said measured cam phase begins to change toward said requested cam phase and that ends when said deviation of the measured cam phase from the requested cam phase falls below a threshold.

7. The control method of claim 6, including the steps of:
determining a change in cam phase that occurs during said time interval; and
disregarding the determined rate of response if the determined change in cam phase differs from said requested change in cam phase by at least a predetermined amount.

8. The control method of claim 1, including the steps of:
defining said nominal rate of response in terms of a first rate threshold that establishes a slower than nominal rate of response and a second rate threshold that establishes a faster than nominal rate of response; and
adaptively adjusting said closed-loop gain terms in a direction to increase a response rate of said mechanism if the determined rate of response is between said first rate threshold and said nominal rate of response.

9. The control method of claim 1, including the steps of:
defining said nominal rate of response in terms of a first rate threshold that establishes a slower than nominal rate of response and a second rate threshold that establishes a faster than nominal rate of response; and
adaptively adjusting said second rate threshold in a direction to increase said nominal rate of response if the determined rate of response is higher than said second rate threshold.
